(19) United States
(12) Patent Application Publication
(10) Pub. No.: US 2004/0266495 A1
(43) Pub. Date: Dec. 30, 2004

(54) Mobile phone holder structure and a clipping method for mobile phone holder

(76) Inventor: Jack Ou, Taipei (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/607,991

(22) Filed: Jun. 30, 2003

(51) Int. Cl. H04M 1/00; H04B 1/08

(52) U.S. Cl. 455/575.1; 455/347; 379/447; 379/455

(57) ABSTRACT

A mobile phone holder structure and a clipping method for a mobile phone holder, the structure comprises two pressing clipping parts, a front cover, a control button, a partition and a back cover, two pressing clipping parts are respectively put into two accommodating grooves of said front cover, the control button is put from the accommodating hole of the side of said front cover, two openings of the control button are respectively locked the anti-reverse part of pressing clipping parts, and engaged with said anti-reverse part by hook, each spring on the partition props two sides in the orientation hole of two pressing clipping parts through each circinate hole on said front cover; said mobile phone is clipped by the clipping claws of the pressing clipping parts which is drove by using the mobile phone to press the pressing clipping parts, and by means of pressing the control button to drive the clipping claws of the pressing clipping parts to loose the mobile phone.

### BACKGROUND OF THE INVENTION

1. Field of the Invention

The invention relates to a mobile phone holder structure and a clipping method for a mobile phone holder, and in particular, to utilize a pressing manner to fix and take out the mobile phone, and a mobile phone holder structure and a clipping method for a mobile phone holder to avoid clipping the sound volume and the earphone jack of the mobile phone.

2. Description of the Prior Art

Conventional mobile phone holder is composed of a front cover and a back cover, and a clipping part is disposed on two sides of front part of the front cover to clip the mobile phone. However, the clipping part of this mobile phone holder is a single piece structure, thus when the clipping part is clipping the mobile phone, it is readily to cover various buttons or devices on the lateral of the mobile phone (such as sound volume and the earphone jack or the like), and is inconvenient to use. Furthermore, the clipping method of the present mobile phone holder is using engagement or prop, so it is troublesome as fixing or taking out the mobile phone. Also, it's easily to cause damage to the case or the clipping part of the mobile phone. In addition, when the present mobile phone holder is clipping the mobile phone, the user needs to use one hand to put the mobile phone in a fixed position, and use the other hand to operate the clipping parts of the holder to clip the mobile phone, and it is much inconvenient for operation.

It shows that the embodiment described above still have much imperfection, and need to be improved.

The inventor has notice the various disadvantages derived from the mobile phone holder structure and the clipping method for the mobile phone holder as mentioned above, and thought to improve it, and after having carried out an intensive study for many years, has successfully developed a mobile phone holder structure and a clipping method for a mobile phone holder.

### SUMMARY OF THE INVENTION

An object of the invention is to provide a mobile phone holder structure and a clipping method for a mobile phone holder for conveniently fix and take out the mobile phone.

Another object of the invention is to provide a mobile phone holder to avoid clipping the sound volume and the earphone jack of the mobile phone.

Another object of the invention is to provide a mobile phone holder to clip or take out the mobile phone by one hand.

Another object of the invention is to provide a mobile phone holder to clip various mobile phones.

A mobile phone holder structure and a clipping method for a mobile phone holder to achieve the object mentioned above comprises:

two pressing clipping parts, each pressing clipping part is configured with some clipping claws, foam is disposed to each clipping claw, and the backside of two pressing clipping parts is configured with anti-reverse parts in the same direction;

a front cover, said front cover is configured with two accommodating grooves, each accommodating groove is configured with a hole to be passed through by anti-reverse parts, some circinate holes are disposed in each accommodating groove, and a side of the front cover is configured with an accommodating hole;

a control button, said board is configured with two openings, a side of two openings is respectively configured with a hook;

a partition, the position of said partition corresponding to each circinate hole on said front cover is configured with a protruding post for inserting said spring; and

a back cover connected to said front cover.

### BRIEF DESCRIPTION OF THE DRAWINGS

The drawings disclose an illustrative embodiment of the present invention which serves to exemplify the various advantages and objects hereof, and are as follows:

FIG. 1 shows a three-dimensional appearance of a mobile phone holder according to the invention;

FIG. 2 shows a three-dimensional disassembly of a part of said mobile phone holder according to the invention;

FIG. 2A shows a three-dimensional appearance with another viewpoint of said mobile phone holder according to the invention;

FIG. 3 shows a three-dimensional disassembly with another viewpoint of said mobile phone holder according to the invention;

FIG. 4 shows a three-dimensional disassembly of the pressing clipping part and control button;

FIG. 5 is an using state diagram of said mobile phone holder.

### DETAILED DESCRIPTION OF THE PREFERRED EMBODIMENT

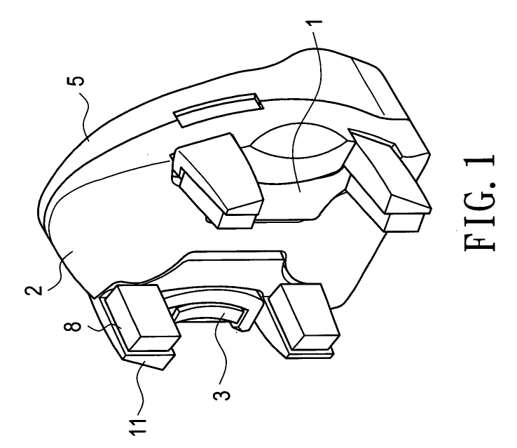

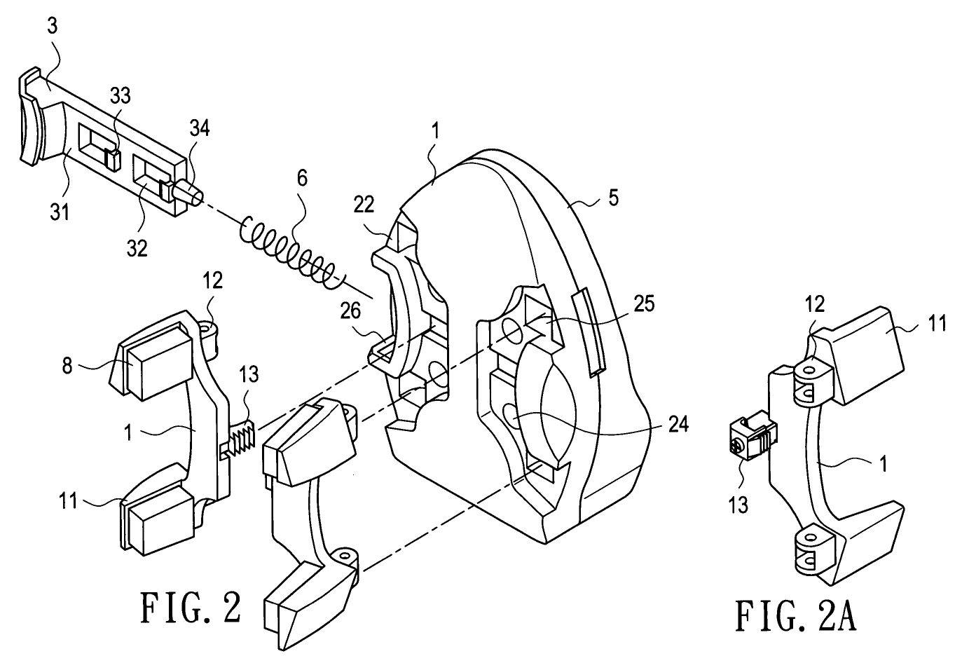

Referring to FIGS. 1, 2, 2A and 3, a mobile phone holder structure and a clipping method for a mobile phone holder provided by the present invention, said structure mainly comprises: two pressing clipping parts 1, wherein said two pressing clipping parts 1 having left part corresponding to right part, each pressing clipping part 1 is configured with some clipping claws 11, the backside of each clipping claw 11 of two pressing clipping parts 1 is configured with some rotatably connecting parts 12 and the backside of two pressing clipping parts 1 is configured with anti-reverse parts 13 in the same direction, and both top side and bottom side of each anti-reverse part 13 are respectively configured with an orientation hole 14;

A front cover 2, the back concave of said front cover 2 is configured with a groove 21, two front sides of front cover 2 are respectively configured with a accommodating groove 22 for accommodating pressing clipping parts 1, a hole 23 is configured to the position of each accommodating groove 22 which is corresponding to the anti-reverse part 13, a circinate hole 24 is configured to the position of each accommodating groove 22 which is corresponding to each orientation hole 14 of pressing clipping parts 1, the front concave of said front cover 2 is configured with some connecting grooves 25 for accommodating rotatably connecting parts 12, in addition, a side of said front cover 2 is configured with an accommodating hole 26, and another side in the groove 21 of the back of said front cover 2 which is corresponding to the position of accommodating hole 26 is configured with a fender 27;

a control button 3, said control button 3 comprises an extended board 31, said board 31 has two openings 32, a side of two openings 32 is respectively configured with a hook 33, and the end of said board 31 is configured with a protruding post 34 connected to a spring 6;

a partition 4, a side of front part of said partition 4 comprises a protruding part 41, the position of said partition 4 corresponding to each circinate hole 24 on said front cover 2 is configured with a protruding post 42 for inserting said spring 6;

a back cover 5 connected to said front cover 2;

two pressing clipping parts 1 are respectively put into two accommodating grooves 22 of said front cover 2, each rotatably connecting parts 12 are respectively connected to each connecting groove 25 by connecting stem 7, the control button 3 is put from the accommodating hole of the side of said front cover 2, two openings 32 of the control button 3 are respectively locked the anti-reverse part 13 of pressing clipping parts 1, and utilizes the hook 33 to engage with anti-reverse part 13, the spring 6 on the control button 3 props the fender 27 of said front cover 2, furthermore, the protruding part 41 of partition 4 props back part of control button 3, each spring 6 on the partition 4 props two sides in the orientation hole 14 of two pressing clipping parts 1 through each circinate hole 24 on said front cover 2, in addition, each clipping claw 11 of pressing clipping parts 1 is configured with foam or other soft and elastic substance, and said anti-reverse part 13 of pressing clipping parts 1 is composed of some units 131, one side of each unit 131 is an incline 132, and the other side is perpendicular plane 133 for anti-reversing.

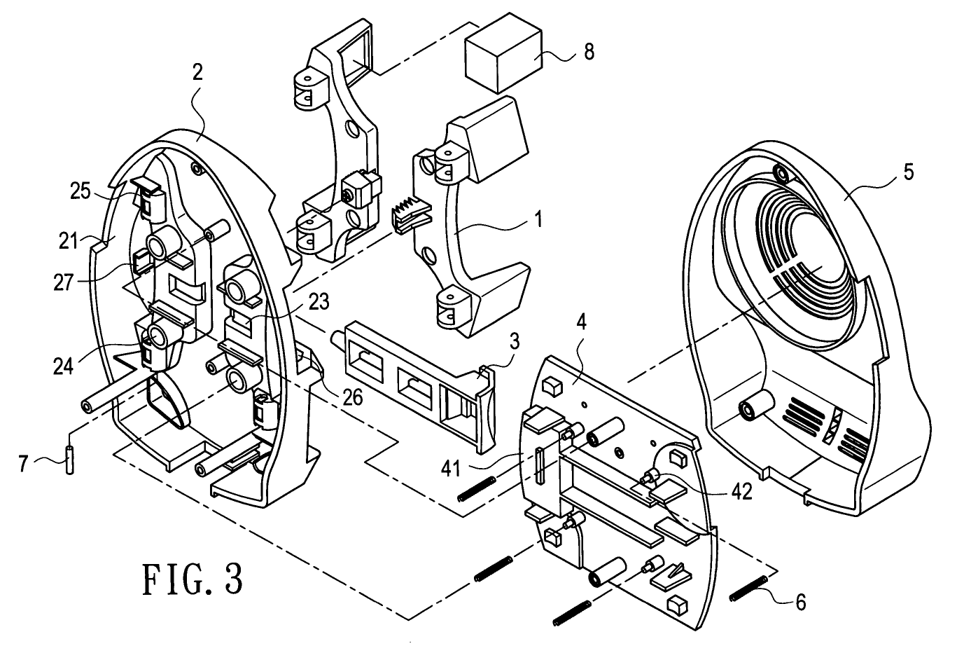

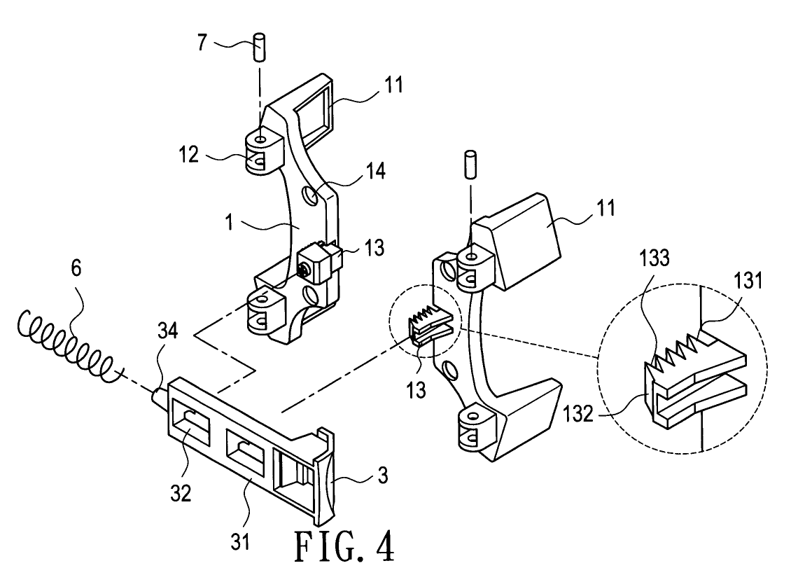

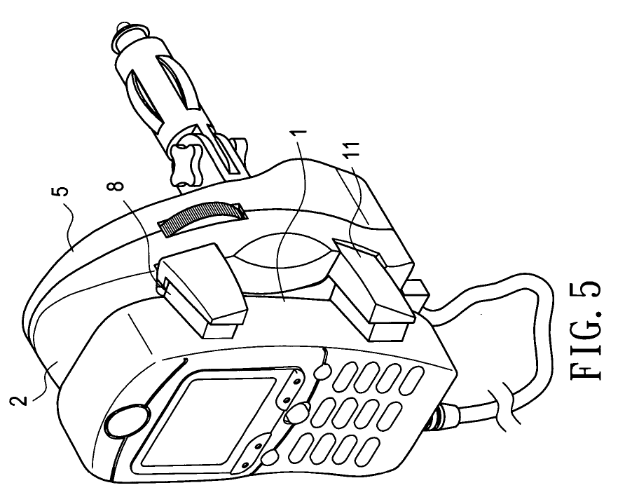

Referring to FIGS. 3 and 4, a mobile phone holder structure and a clipping method for a mobile phone holder provided by the present invention, wherein said anti-reverse part 13 of pressing clipping parts 1 is engaged with said control button 3 by use of the unit 131 of back part of pressing clipping parts 1, the spring 6 of partition 4 pushes said pressing clipping parts 1 out and makes pressing clipping parts 1 respectively form a relative angle to the front side of front cover 2, thus, when a mobile phone is put in a mobile phone holder according to the present invention, said mobile phone is used to prop two pressing clipping parts, makes the units 131 of anti-reverse part 13 generate a relative movement to the hook 33 of control button 3 by an incline 132 of a side of the units 131, when two pressing clipping parts 1 is pressed down and is parallel to the front side of front cover 2, clipping claws 11 are drove to generate a clipping action and clip said mobile phone by use of foam 8 or other soft and elastic substance of clipping claws 11, in the meantime, the hook 33 of control button 3 hooks the units 131 of anti-reverse part 13, makes the units 131 of anti-reverse part 13 engage with the hook 33 of control button 3 by anti-reversing plane 133 of the other side of the units 131 so as to fix the pressing clipping parts 1 for preventing spring 6 on the partition 4 from pushing the pressing clipping parts 1 out and preventing the mobile from falling; moreover, when one user intends to take out the mobile phone from the mobile holder according to the present invention, he just need to press the control button 3 to make the hook 33 of control button 3 come off said anti-reverse part 13 of pressing clipping parts 1, then the pressing clipping parts 1 is pushed out by the elasticity of spring 6 on the partition 4 and drives the clipping claws 11 to be opened, then the mobile phone can be took away from the mobile holder provided by the present invention, afterwards, elasticity said control button 3 props spring 6 on the fender 27 of front cover 2 to generate elasticity for pushing said control button 3 back to its former position and making the hook 33 of control button 3 hook the units 131 of anti-reverse part 13; the mobile phone holder according to the present invention clips a mobile phone by probing pressing clipping parts 1 or pressing the control button 3 to take out a mobile phone, the user can use only one hand to clip the mobile phone or take it off from the holder, hence, it is convenient for operating; moreover, said mobile phone holder structure can also apply to mobile phone charger, hands-free holder or other clipping device of mobile phone (as shown in FIG. 5), due to the anti-reverse part 13 of pressing clipping parts 1 is configured with some units 131, when the holder clips different sizes of mobile phones, the holder can use different unit 131 to engage with the hook 33 of control button 3 according to the size of the mobile phone and cooperate with elasticity of foam 8 or other soft and elastic substance to clip the mobile phone, to achieve the purpose of clipping different mobile phones; in addition, the mobile phone holder structure according to the present invention can also apply to clipping structure of PDA.

A mobile phone holder structure and a clipping method for a mobile phone holder provided by the present invention, when compared with the prior art, the embodiment described above comprises more advantage as following:

1. when a mobile phone is put in a mobile phone holder, said mobile phone props the pressing clipping parts and drives the clipping claws to clip the mobile phone to achieve the purpose for conveniently clipping.

2. by means of pressing the control button to make the pressing clipping parts drive the clipping claws to loose the mobile phone and achieve the purpose for readily taking off.

3. use foam or other soft and elastic substance to clip the mobile phone, therefore, the shape changeability of foam or other soft and elastic substance can do some change according to the shape of the mobile phone and then achieve the purpose for applying to various mobile phones.

4. the pressing clipping parts are configured with some clipping claws, so as to move various buttons or devices on the lateral of the mobile phone to the place between each clipping claw and prevent various buttons or devices on the lateral of the mobile phone from covering by clipping claws.

5. use different unit of anti-reverse part to engage with the hook of control button and cooperate with elasticity of foam or other soft and elastic substance to clip the mobile phone, to achieve the purpose of clipping different mobile phones.

Many changes and modifications in the above described embodiment of the invention can, of course, be carried out without departing from the scope thereof. Accordingly, to promote the progress in science and the useful arts, the invention is disclosed and is intended to be limited only by the scope of the appended claims.

What is claimed is:

1. A mobile phone holder structure which comprises:
two pressing clipping parts, each pressing clipping part is configured with some clipping claws, the backside of two pressing clipping parts is configured with some rotatably connecting parts and anti-reverse parts in the same direction, and both top side and bottom side of each anti-reverse part are configured with an orientation hole;
where in a front cover, is configured with two accommodating grooves, a hole is configured to the position of each accommodating groove which is corresponding to the anti-reverse parst of said two pressing clipping parts, furthermore, the front concave of said front cover is configured with some connecting grooves, a side of said front cover is configured with an accommodating hole, and another side of the back of said front cover which is corresponding to the position of accommodating hole is configured with a fender;
a control button which comprises an extended board, said board has two openings, a side of two openings is respectively configured with a hook, and the end of said board is configured with a protruding post connected to a spring;
a partition, the position of said partition corresponding to each circinate hole on said front cover is configured with a protruding post for inserting said spring; and
a back cover connected to said front cover;
two pressing clipping parts are respectively put into two accommodating grooves of said front cover, the control button is put from the accommodating hole of the side of said front cover, two openings of the control button are respectively locked the anti-reverse part of pressing clipping parts, and utilizes the hook to engage with anti-reverse part, the spring on the control button props the fender of said front cover, furthermore, each spring on the partition props two sides in the orientation hole of two pressing clipping parts through each circinate hole on said front cover.

2. A method for clipping a mobile phone holder structure according to claim 1, when a mobile phone is put in a mobile phone holder, said mobile phone is clipped by the clipping claws which is drove by using the mobile phone to press the pressing clipping parts, and by means of pressing the control button to drive the clipping claws of the pressing clipping parts to loose the mobile phone.

3. The mobile phone holder structure according to claim 1, wherein each clipping claw is configured with foam or other soft and elastic substance.

4. The mobile phone holder structure according to claim 1, wherein said mobile phone holder structure can also apply to mobile phone charger, hands-free holder or other clipping device of mobile phone.

5. The mobile phone holder structure according to claim 1, wherein said anti-reverse part is composed of some units, one side of each unit is inclined, and the other side is perpendicular for anti-reversing.

6. The mobile phone holder structure according to claim 1, wherein said mobile phone holder structure can also apply to clipping structure of PDA.
